(19) United States
(12) Patent Application Publication
(10) Pub. No.: US 2013/0070218 A1
(43) Pub. Date: Mar. 21, 2013

(54) SYSTEM FOR REMOVING CONTAMINANT PARTICLES, LITHOGRAPHIC APPARATUS, METHOD FOR REMOVING CONTAMINANT PARTICLES AND METHOD FOR MANUFACTURING A DEVICE

(71) Applicants: Vladimir Vitalevich Ivanov, Moscow (RU); Pavel Stanislavovich Antsiferov, Troitsk (RU); Yurii Victorovitch Sidelnikov, Troitsk (RU); Luigi Scaccabarozzi, Valkenswaard (NL); Hendrik Antony Johannes Neerhof, Eindhoven (NL); Andrei Mikhailovich Yakunin, Eindhoven (NL); Erik Roelof Loopstra, Eindhoven (NL); Vadim Yevgenyevich Banine, Deurne (NL); Richard Joseph Bruls, Eindhoven (NL)

(72) Inventors: Vladimir Vitalevich Ivanov, Moscow (RU); Pavel Stanislavovich Antsiferov, Troitsk (RU); Yurii Victorovitch Sidelnikov, Troitsk (RU); Luigi Scaccabarozzi, Valkenswaard (NL); Hendrik Antony Johannes Neerhof, Eindhoven (NL); Andrei Mikhailovich Yakunin, Eindhoven (NL); Erik Roelof Loopstra, Eindhoven (NL); Vadim Yevgenyevich Banine, Deurne (NL); Richard Joseph Bruls, Eindhoven (NL)

(73) Assignee: ASML Netherland B.V., Veldhoven, (NL)

(21) Appl. No.: 13/580,364

(22) PCT Filed: Mar. 3, 2011
(86) PCT No.: PCT/EP2011/053171

§ 371 Date: Oct. 25, 2012

Related U.S. Application Data
(60) Provisional application No. 61/313,507, filed on Mar. 12, 2010.
(60) Provisional application No. 61/348,521, filed on May 26, 2010.

(51) Int. Cl. G03B 27/52; C23F 1/08

(52) U.S. Cl. 355/30; 156/345.28

(57) ABSTRACT

A system for removing contaminant particles from the path of the beam of EUV radiation is provided in which at least a first AC voltage is provided to a pair of electrodes on opposite sides of the path of the beam of EUV radiation as a first stage of a regime of voltages and, as a second stage of the regime of voltages, a DC voltage is provided to the electrodes.

### CROSS-REFERENCE TO RELATED APPLICATIONS

This application claims the benefit of U.S. provisional application 61/313,507 which was filed on Mar. 12, 2010 and which is incorporated herein in its entirety by reference. And also claims the benefit of U.S. provisional application 61/348,521 which was filed on May 26, 2010 and which is incorporated herein in its entirety by reference.

### BACKGROUND

1. Field of the Invention

The present invention relates to systems for removing contaminant particles from the path of a beam of EUV radiation, lithographic apparatus, methods of removing contaminant particles from the path of a beam of EUV radiation, and methods for manufacturing a device.

2. Related Art

A lithographic apparatus is a machine that applies a desired pattern onto a substrate, usually onto a target portion of the substrate. A lithographic apparatus can be used, for example, in the manufacture of integrated circuits (ICs). In that instance, a patterning device, which is alternatively referred to as a mask or a reticle, can be used to generate a circuit pattern to be formed on an individual layer of the IC. This pattern can be transferred onto a target portion (e.g., comprising part of, one, or several dies) on a substrate (e.g., a silicon wafer). Transfer of the pattern is typically via imaging onto a layer of radiation-sensitive material (resist) provided on the substrate. In general, a single substrate will contain a network of adjacent target portions that are successively patterned.

Lithography is widely recognized as one of the key steps in the manufacture of ICs and other devices and/or structures. However, as the dimensions of features made using lithography become smaller, lithography is becoming a more critical factor for enabling miniature IC or other devices and/or structures to be manufactured.

A theoretical estimate of the limits of pattern printing can be given by the Rayleigh criterion for resolution as shown in equation (1):

$$CD = {k}_{1} * \frac{λ}{NA} \qquad ( 1 )$$

where λ is the wavelength of the radiation used, NA is the numerical aperture of the projection system used to print the pattern, k1 is a process dependent adjustment factor, also called the Rayleigh constant, and CD is the feature size (or critical dimension) of the printed feature. It follows from equation (1) that reduction of the minimum printable size of features can be obtained in three ways: by shortening the exposure wavelength λ, by increasing the numerical aperture NA or by decreasing the value of k1.

In order to shorten the exposure wavelength and, thus, reduce the minimum printable size, it has been proposed to use an extreme ultraviolet (EUV) radiation source. EUV radiation is electromagnetic radiation having a wavelength within the range of 5-20 nm, for example within the range of 13-14 nm. It has further been proposed that EUV radiation with a wavelength of less than 10 nm could be used, for example within the range of 5-10 nm such as 6.7 nm or 6.8 nm. Such radiation is termed extreme ultraviolet radiation or soft x-ray radiation. Possible sources include, for example, laser-produced plasma sources, discharge plasma sources, or sources based on synchrotron radiation provided by an electron storage ring.

EUV radiation can be produced using a plasma. A radiation system for producing EUV radiation may include a laser for exciting a fuel to provide the plasma, and a source collector module for containing the plasma. The plasma can be created, for example, by directing a laser beam at a fuel, such as particles of a suitable material (e.g., tin), or a stream of a suitable gas or vapor, such as Xe gas or Li vapor. The resulting plasma emits output radiation, e.g., EUV radiation, which is collected using a radiation collector. The radiation collector can be a mirrored normal incidence radiation collector, which receives the radiation and focuses the radiation into a beam. The source collector module may include an enclosing structure or chamber arranged to provide a vacuum environment to support the plasma. Such a radiation system is typically termed a laser produced plasma (LPP) source.

A problem in such systems is that particles of the fuel material tend to be ejected along with the radiation, and can travel at high or low velocities through the apparatus. Where these particles contaminate optical surfaces such as the minor lenses or the reticle, performance of the apparatus is degraded.

Depending on the situation, the photoelectric charging may not be enough to deflect all the unwanted particles. A further problem arises in trying to apply this technique in the hydrogen environment mentioned above. Where gas (H₂) is present, the EUV radiation pulses will generate a conductive hydrogen plasma. When this H₂ plasma (generated by the EUV beam) is present in the region between the capacitor plates, the applied E-field will be screened by plasma, and will not deflect the particles. Additionally, the plasma will gradually apply a negative charge to the particles, erasing the positive charge of the photoelectric effect.

### SUMMARY

Therefore, what is needed is an effective system and method to provide an alternative system for removing contaminant particles suitable for EUV apparatus within an atmosphere, e.g., hydrogen.

In an embodiment of the present invention, there is provided a system for removing contaminant particles from the path of a beam of EUV radiation in a lithographic apparatus, including at least one pair of electrodes provided on opposite sides of the path of the beam of EUV radiation and a voltage source, configured to provide a controlled voltage between at least one pair of electrodes. The system includes a controller, configured to control the voltage provided between at least one of the pair of electrodes, where the controller is configured to provide a regime of voltages between the electrodes, where the regime includes a first stage in which an alternating current (“AC”) voltage is provided to a pair of the electrodes, and a second stage in which a direct current (“DC”) voltage is provided to a pair of the electrodes.

In an embodiment of the present invention, the system further provides a lithographic apparatus incorporating one or more such systems for removing contaminant particles.

In an embodiment of the present invention, there is provided a method for removing contaminant particles from the path of a beam of EUV radiation in a lithographic apparatus, including providing at least one pair of electrodes provided on opposite sides of the path of the beam of EUV radiation, and providing a regime of voltages between at least one pair of electrodes, the regime including a first stage, in which an AC voltage is provided to a pair of the electrodes, and a second stage, in which a DC voltage is provided to the electrodes.

In an embodiment of the present invention a method of manufacturing a device, for example a semiconductor device, using the contaminant removal method set forth above, is provided.

Further embodiments, features, and advantages of the present invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS

Embodiments of the invention will now be described, by way of example only, with reference to the accompanying schematic drawings in which corresponding reference symbols indicate corresponding parts. Further, the accompanying drawings, which are incorporated herein and form part of the specification, illustrate the present invention, and, together with the description, further serve to explain the principles of the invention and to enable a person skilled in the relevant art(s) to make and use the invention.

FIG. 1 depicts schematically a lithographic apparatus according to an embodiment of the present invention.

FIG. 2 is a more detailed view of the apparatus 100, according to an embodiment of the present invention.

FIG. 3 illustrates an alternative EUV radiation source usable in the apparatus of FIGS. 1 and 2, according to an embodiment of the present invention.

FIG. 4 illustrates a modified lithographic apparatus according to an embodiment of the present invention.

FIG. 5 illustrates an embodiment of a system for removing contaminant particles according to an embodiment of the present invention.

FIGS. 6 and 7 compare the performance of a previously known system for removing contaminant particles with a system according to an embodiment of the present invention.

FIG. 8 depicts an alternative embodiment of a system for removing contaminant particles according to an embodiment of the present invention.

FIGS. 9 and 10 compare the performance of a system as depicted in FIG. 8 for particles of high and low secondary electron emission coefficient materials, respectively, according to an embodiment of the present invention.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION OF THE INVENTION

This specification discloses one or more embodiments that incorporate the features of this invention. The disclosed embodiment(s) merely exemplify the invention. The scope of the invention is not limited to the disclosed embodiment(s). The invention is defined by the claims appended hereto.

The embodiment(s) described, and references in the specification to “one embodiment,” “an embodiment,” “an example embodiment,” etc., indicate that the embodiment(s) described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is understood that it is within the knowledge of one skilled in the art to affect such feature, structure, or characteristic in connection with other embodiments whether or not explicitly described.

Embodiments of the invention can be implemented in hardware, firmware, software, or any combination thereof. Embodiments of the invention can also be implemented as instructions stored on a machine-readable medium, which can be read and executed by one or more processors. A machine-readable medium can include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g.,, carrier waves, infrared signals, digital signals, etc.), and others. Further, firmware, software, routines, instructions can be described herein as performing certain actions. However, it should be appreciated that such descriptions are merely for convenience and that such actions in fact result from computing devices, processors, controllers, or other devices executing the firmware, software, routines, instructions, etc.

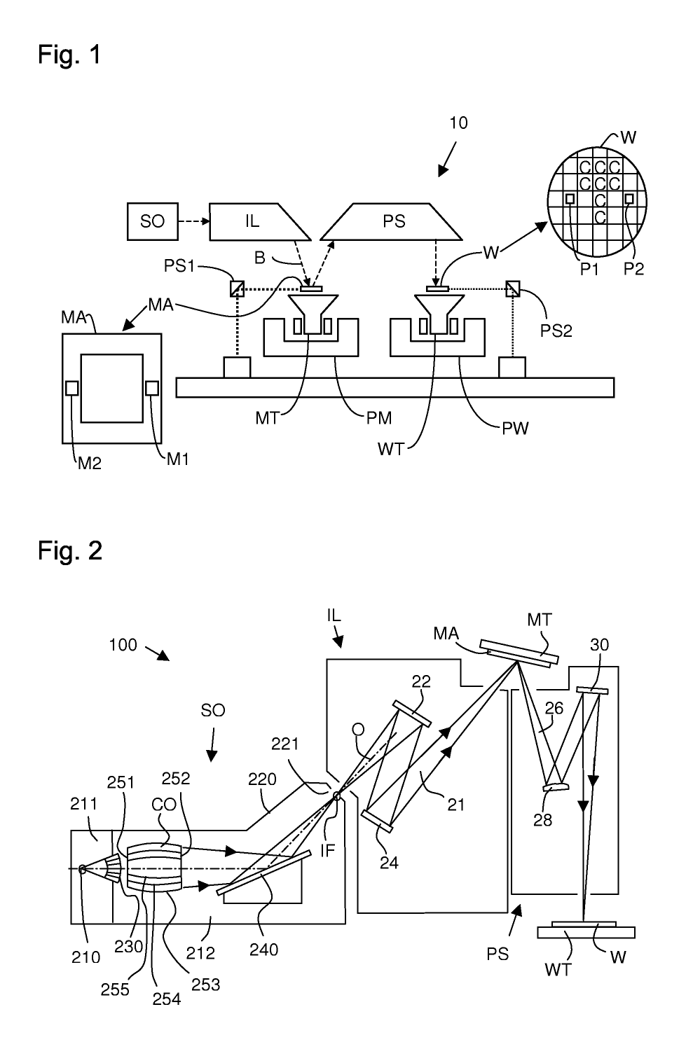

FIG. 1, according to an embodiment of the present invention, schematically depicts a lithographic apparatus 100 including a source collector module SO according to one embodiment of the invention. The apparatus includes an illumination system (illuminator) IL configured to condition a radiation beam B (e.g., EUV radiation) and a support structure (e.g., a mask table) MT constructed to support a patterning device (e.g., a mask or a reticle) MA and connected to a first positioner PM configured to accurately position the patterning device. Apparatus 100 also includes a substrate table (e.g., a wafer table) WT constructed to hold a substrate (e.g., a resist-coated wafer) W and connected to a second positioner PW configured to accurately position the substrate, and a projection system (e.g., a reflective projection system) PS configured to project a pattern imparted to the radiation beam B by patterning device MA onto a target portion C (e.g., comprising one or more dies) of the substrate W.

The illumination system may include various types of optical components, such as refractive, reflective, magnetic, electromagnetic, electrostatic, or other types of optical components, or any combination thereof, for directing, shaping, or controlling radiation.

The support structure MT holds the patterning device MA in a manner that depends on the orientation of the patterning device, the design of the lithographic apparatus, and other conditions, such as for example whether or not the patterning device is held in a vacuum environment. The support structure can use mechanical, vacuum, electrostatic, or other clamping techniques to hold the patterning device. The support structure can be a frame or a table, for example, which can be fixed or movable as required. The support structure may ensure that the patterning device is at a desired position, for example with respect to the projection system.

The term “patterning device” should be broadly interpreted as referring to any device that can be used to impart a radiation beam with a pattern in its cross-section such as to create a pattern in a target portion of the substrate. The pattern imparted to the radiation beam may correspond to a particular functional layer in a device being created in the target portion, such as an integrated circuit.

The patterning device can be transmissive or reflective. Examples of patterning devices include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small minors, each of which can be individually tilted so as to reflect an incoming radiation beam in different directions. The tilted mirrors impart a pattern in a radiation beam that is reflected by the mirror matrix.

The term “projection system” used herein should be broadly interpreted as encompassing various type of projection systems, and like the illumination system, may include various types of optical components, such as refractive, reflective, magnetic, electromagnetic, electrostatic or other types of optical components, or any combination thereof, as appropriate for the exposure radiation being used, or for other factors such as the use of a vacuum. It may be desired to use a vacuum for EUV radiation since other gases may absorb too much radiation. A vacuum environment may therefore be provided to the whole beam path with the aid of a vacuum wall and vacuum pumps.

In this embodiment, for example, the apparatus is of a reflective type (e.g., employing a reflective mask).

The lithographic apparatus can be of a type having two (dual stage) or more substrate tables and for example, two or more mask tables. In such “multiple stage” machines the additional tables can be used in parallel, or preparatory steps can be carried out on one or more tables while one or more other tables are being used for exposure.

Referring to FIG. 1, the illuminator IL receives an extreme ultra violet radiation beam from the source collector module SO. Methods to produce EUV light include, but are not necessarily limited to, converting a material into a plasma state that has at least one element, e.g., xenon, lithium or tin, with one or more emission lines in the EUV range. In one such method, often termed laser produced plasma (“LPP”) the required plasma can be produced by irradiating a fuel, such as a droplet, stream, or cluster of material having the required line-emitting element, with a laser beam. The source collector module SO can be part of a EUV radiation system including a laser, not shown in FIG. 1, for providing the laser beam exciting the fuel. The resulting plasma emits output radiation, e.g., EUV radiation, which is collected using a radiation collector, disposed in the source collector module. The laser and the source collector module can be separate entities, for example when a CO2 laser is used to provide the laser beam for fuel excitation.

In such cases, the laser is not considered to form part of the lithographic apparatus and the radiation beam is passed from the laser to the source collector module with the aid of a beam delivery system comprising, for example, suitable directing mirrors and/or a beam expander. In other cases the source can be an integral part of the source collector module, for example when the source is a discharge produced plasma EUV generator, often termed as a DPP source.

The illuminator IL may comprise an adjuster for adjusting the angular intensity distribution of the radiation beam. Generally, at least the outer and/or inner radial extent, which are commonly referred to as σ-outer and σ-inner, respectively, of the intensity distribution in a pupil plane of the illuminator can be adjusted. In addition, the illuminator IL may comprise various other components, such as facetted field and pupil mirror devices. The illuminator can be used to condition the radiation beam, to have a desired uniformity and intensity distribution in its cross-section.

The radiation beam B is incident on the patterning device (e.g., mask) MA, which is held on the support structure (e.g., mask table) MT, and is patterned by the patterning device. After being reflected from the patterning device (e.g., mask) MA, the radiation beam B passes through the projection system PS, which focuses the beam onto a target portion C of the substrate W. With the aid of the second positioner PW and position sensor PS2 (e.g., an interferometric device, linear encoder or capacitive sensor), the substrate table WT can be moved accurately, e.g., so as to position different target portions C in the path of the radiation beam B. Similarly, the first positioner PM and another position sensor PS1 can be used to accurately position the patterning device (e.g., mask) MA with respect to the path of the radiation beam B. Patterning device (e.g., mask) MA and substrate W can be aligned using mask alignment marks M1, M2 and substrate alignment marks P1, P2.

The depicted apparatus could be used in at least one of the following modes:
1. In step mode, the support structure (e.g., mask table) MT and the substrate table WT are kept essentially stationary, while an entire pattern imparted to the radiation beam is projected onto a target portion C at one time (i.e., a single static exposure). The substrate table WT is then shifted in the X and/or Y direction so that a different target portion C can be exposed.
2. In scan mode, the support structure (e.g., mask table) MT and the substrate table WT are scanned synchronously while a pattern imparted to the radiation beam is projected onto a target portion C (i.e., a single dynamic exposure). The velocity and direction of the substrate table WT relative to the support structure (e.g., mask table) MT can be determined by the (de-) magnification and image reversal characteristics of the projection system PS.
3. In another mode, the support structure (e.g., mask table) MT is kept essentially stationary holding a programmable patterning device, and the substrate table WT is moved or scanned while a pattern imparted to the radiation beam is projected onto a target portion C. In this mode, generally a pulsed radiation source is employed and the programmable patterning device is updated as required after each movement of the substrate table WT or in between successive radiation pulses during a scan. This mode of operation can be readily applied to maskless lithography that utilizes programmable patterning device, such as a programmable mirror array of a type as referred to above.

Combinations and/or variations on the above described modes of use or entirely different modes of use may also be employed.

FIG. 2, according to an embodiment of the present invention, shows the apparatus 100 in more detail, including the source collector module SO, the illumination system IL, and the projection system PS. The source collector module SO is constructed and arranged such that a vacuum environment can be maintained in an enclosing structure 220 of the source collector module SO. A EUV radiation emitting plasma 210 can be formed by a discharge produced plasma source. EUV radiation can be produced by a gas or vapor, for example Xe gas, Li vapor or Sn vapor, in which the very hot plasma 210 is created to emit radiation in the EUV range of the electromagnetic spectrum. The very hot plasma 210 is created by, for example, an electrical discharge causing at least partially ionized plasma. Partial pressures of, for example, 10 Pa of Xe, Li, Sn vapor or any other suitable gas or vapor can be required for efficient generation of the radiation. In an embodiment, a plasma of excited tin (Sn) is provided to produce EUV radiation.

The radiation emitted by the hot plasma 210 is passed from a source chamber 211 into a collector chamber 212 via an optional gas barrier or contaminant trap 230 (in some cases also referred to as contaminant barrier or foil trap) that is positioned in or behind an opening in source chamber 211. The contaminant trap 230 can include a channel structure. Contaminant trap 230 can also include a gas barrier or a combination of a gas barrier and a channel structure. The contaminant trap or contaminant barrier 230 further indicated herein at least includes a channel structure, as known in the art.

The collector chamber 211 can include a radiation collector CO that can be a grazing incidence collector. Radiation collector CO has an upstream radiation collector side 251 and a downstream radiation collector side 252. Radiation that traverses collector CO can be reflected off a grating spectral filter 240 to be focused in a virtual source point IF. The virtual source point IF, also referred to as the intermediate focus, and the source collector module is arranged such that the intermediate focus IF is located at or near an opening 221 in the enclosing structure 220. The virtual source point IF is an image of the radiation emitting plasma 210.

Subsequently, the radiation traverses the illumination system IL, which can include a facetted field mirror device 22 and a facetted pupil mirror device 24 arranged to provide a desired angular distribution of the radiation beam 21, at the patterning device MA, as well as a desired uniformity of radiation intensity at the patterning device MA. Upon reflection of the beam of radiation 21 at the patterning device MA, held by the support structure MT, a patterned beam 26 is formed and the patterned beam 26 is imaged by the projection system PS via reflective elements 28, 30 onto a substrate W held by the wafer stage or substrate table WT.

More elements than shown can generally be present in illumination optics unit IL and projection system PS. The grating spectral filter 240 can optionally be present, depending upon the type of lithographic apparatus. Further, there can be additional minors present than those shown in the Figures, for example there can be 1- 6 additional reflective elements present in the projection system PS than shown in FIG. 2.

Collector optic CO, as illustrated in FIG. 2, is depicted as a nested collector with grazing incidence reflectors 253, 254 and 255, as an example of a collector (or collector minor). The grazing incidence reflectors 253, 254, and 255 are disposed axially symmetric around an optical axis O and a collector optic CO of this type is preferably used in combination with a discharge produced plasma source, often called a DPP source.

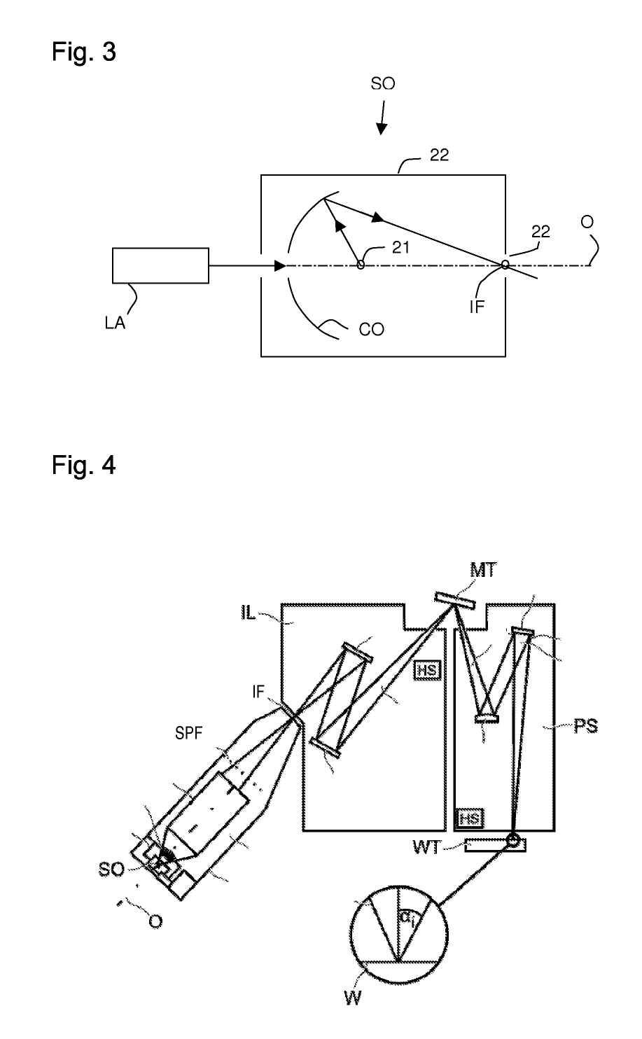

In an embodiment of the present invention, the source collector module SO can be part of an LPP radiation system as shown in FIG. 3. A laser LA is arranged to deposit laser energy into a fuel, such as xenon (Xe), tin (Sn) or lithium (Li), creating the highly ionized plasma 210 with electron temperatures of several 10's of eV. The energetic radiation generated during de-excitation and recombination of these ions is emitted from the plasma, collected by a near normal incidence collector optic CO and focused onto the opening 221 in the enclosing structure 220.

FIG. 4, according to an embodiment of the present invention, shows an arrangement for a EUV lithographic apparatus in which the spectral purity filter SPF is of a transmissive type, rather than a reflective grating. The radiation from source SO in this case follows a straight path from the collector to the intermediate focus IF (virtual source point). In alternative embodiments, not shown, the spectral purity filter 11 can be positioned at the virtual source point 12 or at any point between the collector 10 and the virtual source point 12. The filter can be placed at other locations in the radiation path, for example downstream of the virtual source point 12. Multiple filters can be deployed. As in the previous examples, the collector CO can be of the grazing incidence type (FIG. 2) or of the direct reflector type (FIG. 3).

As mentioned above, a contaminant trap 230 including a gas barrier is provided in the source compartment. The gas barrier includes a channel structure such as, for instance, described in detail in U.S. Pat. No. 6,614,505 and U.S. Pat. No. 6,359,969, which are incorporated herein by reference in their entireties. The purpose of this contaminant trap is to prevent or at least reduce the incidence of fuel material or by-products impinging on the elements of the optical system and degrading their performance over time. The gas barrier may act as a physical barrier (by fluid counter-flow), by chemical interaction with contaminants and/or by electrostatic or electromagnetic deflection of charged particles. In practice, a combination of these methods can be employed to permit transfer of the radiation into the illumination system, while blocking the plasma material to the greatest extent possible. As explained in the above referenced U.S. patents, hydrogen radicals in particular can be injected for chemically modifying the Sn or other plasma materials. Hydrogen radicals can also be applied for cleaning of Sn and other elements that may already be deposited on the optical surfaces.

Hydrogen or other gas can be provided as a barrier or buffer against contaminant particles at other points in the lithographic apparatus. In particular, a flow of hydrogen into the source compartment SO can be arranged, to impede particles that may try to pass through the intermediate focus aperture 221 into the projection system. Further, hydrogen gas can be deployed (i) in the vicinity of the reticle support MT, as a buffer against contaminants from the system contaminating the reticle and (ii) in the vicinity of the wafer support WT, as a buffer against contaminants from the wafer entering the larger vacuum spaces within the system.

For all these purposes, hydrogen sources HS (some shown, some not shown) deployed for the supplying hydrogen gas to each contaminant trap arrangement. Some sources may supply molecular hydrogen gas (H₂) as a simple buffer while others generate H radicals.

U.S. Pat. No. 6,781,673 (“the '673 patent”), which is incorporated by reference herein in its entirety, and which is co-owned, proposes electrostatic deflection to protect a reticle. The same principles can be applied in protecting other components and spaces of the lithographic apparatus. The '673 patent proposes charging of particle using photoelectric effect of the EUV beam itself, which yields a positive charge on the tin particles.

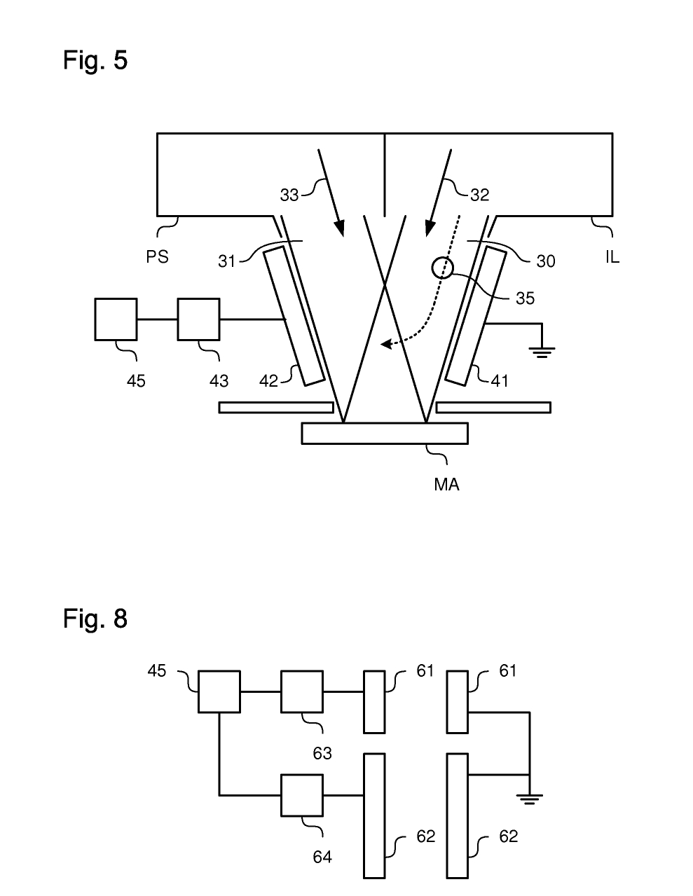

FIG. 5, according to an embodiment of the present invention, depicts a system for removing contaminant particles from the path of a beam of EUV radiation in a lithographic apparatus according to an embodiment of the present invention. In this arrangement, the system for removing contaminant particles is provided in the region of a lithographic apparatus in which the beam of EUV radiation 30 is provided by the illumination system IL and is incident on a patterning device MA and the patterned beam of EUV radiation is directed into the projection system PS.

As explained above and as shown in FIG. 5, hydrogen gas is provided within both the illumination system IL and the projection system PS, resulting in a flow 32, 33 of hydrogen gas from the illumination system IL and projection system PS, respectively towards the patterning device MA. The flow 32 of hydrogen gas from the illumination system IL, in particular, may entrain contaminant particles, for example from the source SO. It is therefore desirable to prevent such contaminant particles 35 from reaching the patterning device MA. For example, particles as small as 20 nm deposited on the patterning device MA may cause a fatal defect in every die that is subsequently formed on a substrate.

In the system for removing contaminant particles of the present invention, a pair of electrodes 41, 42 can be provided on either side of the path of the beam of EUV radiation. As shown in FIG. 5, the electrodes 41, 42 can be positioned on either side of the beam of EUV radiation adjacent the patterning device MA, such that the pair of electrodes 41, 42 are on opposite sides of both the beam of EUV radiation 30 provided by the illumination system IL and on either side of the beam of EUV radiation 31 that is directed from the patterning device MA into the projection system PS.

In common with previously proposed systems for removing contaminant particles, a voltage source 43 is provided that establishes a controlled voltage between the pair of electrodes 41, 42. Accordingly, contaminant particles 35 that are provided with an electrostatic charge can be drawn to one of the electrodes 42 and removed from the path of the beam of the EUV radiation.

In one embodiment, as shown, one of the electrodes 41 can be grounded and a positive voltage can be provided to the other electrode 42 such that negatively charged particles are drawn to it. It will be appreciated, however, that either electrode 41, 42 maybe grounded and the other provided with a voltage. Furthermore, in an alternative embodiment, a positive voltage can be provided to either one of the electrodes 41, 42 and a negative voltage can be provided to the other of the electrodes 41, 42, providing a desired voltage difference between the pair of electrodes 41, 42. Such an arrangement may have the advantage of better confining the electric field in the space between the pair of electrodes, 41, 42 because other surfaces near the electrodes 41, 42 can be grounded.

However, in contrast with previously proposed electrostatic contaminant removal systems, the present invention includes a controller 45 that is configured to control the voltage source 43 in order to provide a specific regime of voltages. By careful selection of the regime of voltages applied to the pair of electrodes 41, 42, improved performance of the system for removing contaminant particles can be provided in comparison, for example, with a system that provides a constant DC voltage to the pair of electrodes 41, 42.

As discussed above, previous proposed electrostatic systems for removing contaminant particles were based on the use of the photoelectric effect of the EUV beam to provide a positive charge to the contaminant particles. However, the presence of the hydrogen gas results in the formation of a conductive hydrogen plasma by the EUV radiation. This plasma may screen the contaminant particles from the electrostatic field provided by the voltage difference between the electrodes 41, 42. Furthermore, the hydrogen plasma may gradually apply a negative charge to the contaminant particles, erasing the positive charge of the photoelectric effect. An embodiment of the present invention is based upon a realization that by providing a more sophisticated regime of voltages to the electrodes 41, 42, one may improve the performance of the system.

In particular, an embodiment of the present invention may use a regime of voltages that includes a first stage, in which an AC voltage is provided to the pair of electrodes 41, 42 and a second stage, in which a DC voltage is provided to the pair of electrodes 41, 42.

The second stage of the regime functions to attract the charged contaminant particles 35 to one of the electrodes 41, 42, in a similar manner to the previously proposed system. The first stage is provided to interact with the formation of the hydrogen plasma in order to improve the performance of the second stage.

In an embodiment of the present invention, the AC voltage of the first stage is selected to increase the density of the hydrogen plasma generated by the beam of EUV radiation. In such an embodiment, the increase in density of the plasma can be sufficient so that the contaminant particles 35 become relatively strongly negatively charged, namely more than compensating for the positive charge of the photoelectric effect. By increasing the magnitude of the net charge on the contaminant particles 35, the probability can be increased that an individual particle 35 will be sufficiently deflected from its initial trajectory by the voltage of the second stage that it is captured by the electrode 42.

In another embodiment of the present invention, the AC voltage of the first stage is selected such that the AC voltage provided between the pair of electrodes 41, 42 has the effect of dissipating the hydrogen plasma that has been generated by the beam of EUV radiation.

It should be appreciated that the hydrogen plasma formed by the EUV radiation will, in any case, dissipate naturally over time. However, by providing an appropriately selected AC voltage in the first stage, the hydrogen plasma can be dissipated more quickly than would naturally occur. Therefore, the screening effect of the hydrogen plasma can be removed or reduced during the second stage. Accordingly, for a given charge applied to a contaminant particle 35, the effect of a DC voltage applied to the electrodes 41, 42 in the second stage will be greater. In turn, this increases the probability of a given contaminant particle 35 being drawn to the electrode 42.

In a further arrangement of the voltage regime used in an embodiment of the present invention, an intermediate stage can be provided, in which an AC voltage is provided to the electrodes 41, 42. In such an arrangement, the AC voltage of the first stage can be selected to increase the plasma density of a hydrogen plasma generated by the EUV beam, as discussed above. The AC voltage of the intermediate stage may subsequently be selected to dissipate the plasma more quickly than would naturally occur.

Accordingly, in such an arrangement, the system may benefit from the first stage increasing the plasma density and therefore increasing the magnitude of an electrostatic charge applied to a contaminant particle 35. Subsequently, the intermediate stage may increase the speed at which the plasma is dissipated, such that the screening effect of the plasma is removed or reduced before the second stage, in which a DC voltage is used to draw the contaminant particles 35 to one of the electrodes 42.

As explained above, in an embodiment of a system for removing contaminant particles according to the present embodiment, the required voltages of each of the stages of the regime in voltages are provided between the pair of electrodes 41, 42 in successive periods of time. The beam of EUV radiation may in particular be provided by a pulsed source. Accordingly, the controller 45 can be configured to provide the required stages of the regime and voltages in synchronism with the pulses of the beam of EUV radiation.

In particular, the sum of the time periods of each of the stages of the regime of voltages may correspond to the time between the start of successive pulses of the EUV beam of radiation.

In an embodiment of the present invention, the second stage of the regime of voltages, namely the provision of a DC voltage, can be provided in the period between successive pulses of beam of EUV radiation, in particular immediately prior to a subsequent pulse of EUV radiation.

Where the AC voltage of the first stage of the regime of voltage is selected to concentrate the plasma density, it can be timed to coincide with the pulses of EUV radiation and/or the time period immediately following the pulse of EUV radiation.

A stage of the regime in which the AC voltage is configured to dissipate the plasma can be timed to be provided shortly after the pulse of EUV radiation. If a first stage of the regime is also used to concentrate the plasma density, the intermediate stage, configured to dissipate the plasma, may follow immediately or shortly after the first stage.

In a lithographic apparatus using a pulsed source of EUV radiation, the pulse rate can be, for example, 50 kHz, resulting in a pulse period, namely the time between the start of successive pulses of the beam of EUV radiation, of 20 μs. It will be appreciated that other pulse rates, such as 100 and 200 kHz, for example, may also be used.

In general, it will be desirable for the second stage, namely the stage of the regime providing a DC voltage, to last as long as possible in order to maximize the probability of a particle being drawn to the electrode 42. In an embodiment, the period of time of the second stage of the regime of voltages may correspond to at least 40%, at least 50%, or at least 60% of the time between the start of successive pulses of the beam of EUV radiation.

A stage of the regime of voltages according to the present invention used to increase the charge density of the plasma may preferably be as short as possible.

Such an arrangement provides as much time as possible for the plasma to dissipate, either naturally or assisted by an AC voltage provided in an intermediate stage in the regime of voltages, before the second stage, in which the DC voltage is provided to attract the charged contaminant particle 35. In an embodiment according to the present invention, the time period for a stage of the regime of voltages used to increase the plasma density can be between 5 and 15%, desirably less then 10%, of the time between the start of successive pulses of the beam of EUV radiation.

The period of time for a stage of the regime of voltages according to the present invention used to assist in dissipating the plasma may desirably be sufficiently short that there remains sufficient time for the second stage of the regime of voltages, in which the DC voltage is provided to attract the charged contaminant particles to the electrode 42, before the subsequent pulse of the beam of EUV radiation. However, it must also be sufficiently long that the plasma has dissipated sufficiently that the second stage is effective, namely that the screening effect of the plasma is sufficiently reduced. In an arrangement, such a stage in a regime of voltages of the present invention may correspond to less than 30%, desirably less than 20%, of the time between the start of successive pulses of the beam of EUV radiation.

In selecting the voltages for use in the stages of the regime of voltages used in the present invention, namely the magnitude and frequency of the voltages, it is necessary to consider the configuration of the system, including the geometry of the elements of the system. In particular, the following factors may affect the choice of voltages to be used:

the separation of the electrodes 41, 42, which, together with the voltage applied to the electrodes, 41, 42 determine the electric field strength;

the expected velocity of contaminant particles 35 and their expected range of masses;

the length of the electrodes 41, 42 in the direction of travel of the contaminant particles, which determines the time in which particles can be in the space bounded by the electrodes 41, 42;

the pressure of the hydrogen gas between the electrodes 41,42, which will affect the formation of the plasma in the space between the electrodes 41,42, the increase in plasma density provided by an AC voltage and the subsequent dissipation of the plasma, either naturally or with assistance; and

the timing and power of the beam of EUV radiation.

In setting up the system of the present invention, it should be understood that a contaminant particle can be within the space bounded by the electrodes 41, 42 for a plurality of pulses of the beam of EUV radiation. Accordingly, the system can be configured such that the contaminant particle 35 experiences a plurality of cycles of the regime of voltages, corresponding to a plurality of pulses of the beam of EUV radiation. Each cycle may increase the charge on the contaminant particle. For example, in an expected configuration of a lithographic apparatus having a pulse rate of 50 kHz, the velocity of the contaminant particles can be approximately 20 m/s. In this case, for a pair of electrodes, 41, 42 having a length of, for example, 60 mm, the particle 35 can be between the electrodes 41, 42 for approximately 150 pulses of the beam of EUV radiation.

In each pulse, namely during each cycle of the regime of voltages, the net charge on the contaminant particle 35 may increase and, in each pulse, a force is exerted on the contaminant particle 35 during the second stage of the regime of voltages.

In a possible configuration of the electrodes 41,42, the electrodes can be 60 mm in length (namely in the direction in which the contaminant particles are expected to travel), may have a width of about 100 mm and maybe separated by approximately 40 to 90 mm. It will be appreciated, however, that in general the electrode will be configured to be as wide as the beam of EUV radiation and follow as closely as possible the shape of the beam. The pressure of the hydrogen in the space between the electrodes 41, 42 may, for example, be approximately 3 Pa.

In such an exemplary embodiment, the AC voltage selected for a stage of the regime of voltages to be used to increase the density of the plasma generated by the beam of EUV radiation can be selected to have a frequency of between 20 and 100 MHz and a magnitude of between 40 and 200V. Furthermore, the power supplied to the pair of electrodes 41, 42 in this stage of the regime of voltages can be selected to be between 0.005 and 0.04 W/cm², based on the area of each of the electrodes.

The AC voltage for a stage of the regime of voltages to be used to promote dissipation of the plasma in the exemplary embodiment discussed above can be selected to have a frequency of between 0.1 and 20 MHz, desirably approximately 10 MHz, and a magnitude of between 10 and 400V, desirably approximately 200V.

Finally, in selecting the DC voltage to be used in the second stage of the regime of voltages for the exemplary embodiment discussed above, the DC voltage can be selected from a range of 100 to 400V, for example 200V.

It should be appreciated that in selecting the voltages for a stage to promote dissipation of the plasma and/or the voltage for the second stage of the regime of voltage, the magnitude of the voltage must be selected to be sufficiently low that it does not sustain a plasma. The maximum voltage that can be used for such stages can be determined, accordingly, for a particular configuration of the system, using Paschen's curves.

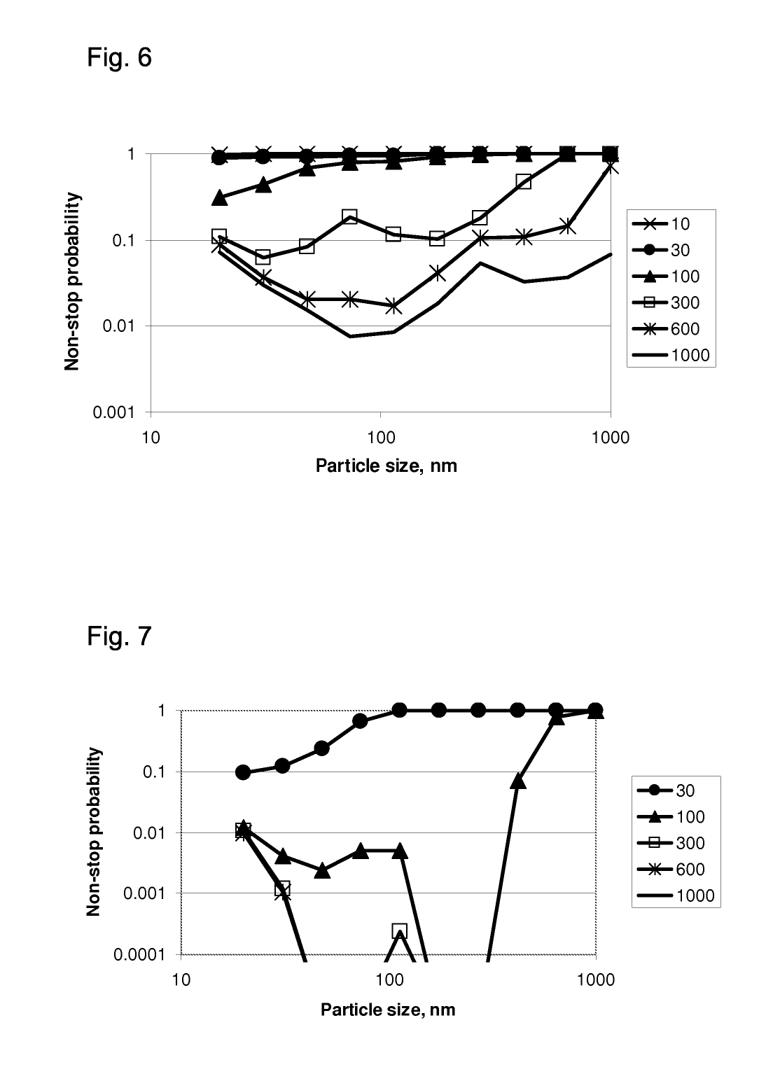

FIGS. 6 and 7, according to embodiments of the present invention, compare the results of simulations of using a system such as that depicted in FIG. 5 in which a constant voltage of 200V is applied to the electrodes 41,42 (FIG. 6) and an arrangement in which a three-stage voltage regime was provided (FIG. 7). In particular, the regime includes a first stage of 40V, 100 MHz for 2 μs, an intermediate stage of 400V, 0.25 MHz for 6 μs and a second stage of 400V DC for 12 μs.

In both FIGS. 6 and 7, the graphs depict the non-stop probability distribution by particle size for a plurality of different numbers of pulses for which the particle is expected to be within the space bounded by the electrodes 41, 42, namely corresponding to variations of the general configuration of the system, including the size of the electrodes and the expected speed of the contaminant particles. As shown, the performance of the three-stage voltage regime is a significant improvement over a system using a constant DC voltage.

Although the present invention has been described above in the context of the embodiment depicted in FIG. 5, it should be appreciated that the present invention can be implemented by alternative embodiments. For example, as depicted in FIG. 8, according to an embodiment of the present invention, illustrates two pairs of electrodes 61, 62 that can be provided, together with associated respective voltage controllers 63, 64.

For example, a voltage source 63 can be controlled by the controller 45 to provide the required voltage for the first stage of the voltage regime to the first pair of electrodes 61 and a second voltage source 64 may provide the required voltages of the intermediate and second stages of the voltage regime to the second pair of electrodes 62. In a first region, between the first pair of electrodes 61, the contaminant particles are charged by the plasma, which has an increased density as a result of the voltages applied to the first pair of electrodes 61 according to the first stage of this regime. Subsequently, in the space between the second pair of electrodes 62, the intermediate stage of the voltage regime is applied to the second pair of electrodes 62 in order to dissipate the plasma before the second stage of the voltage regime, namely a DC voltage, is provided to the second pair of electrodes 62 in order to remove the contaminant particles.

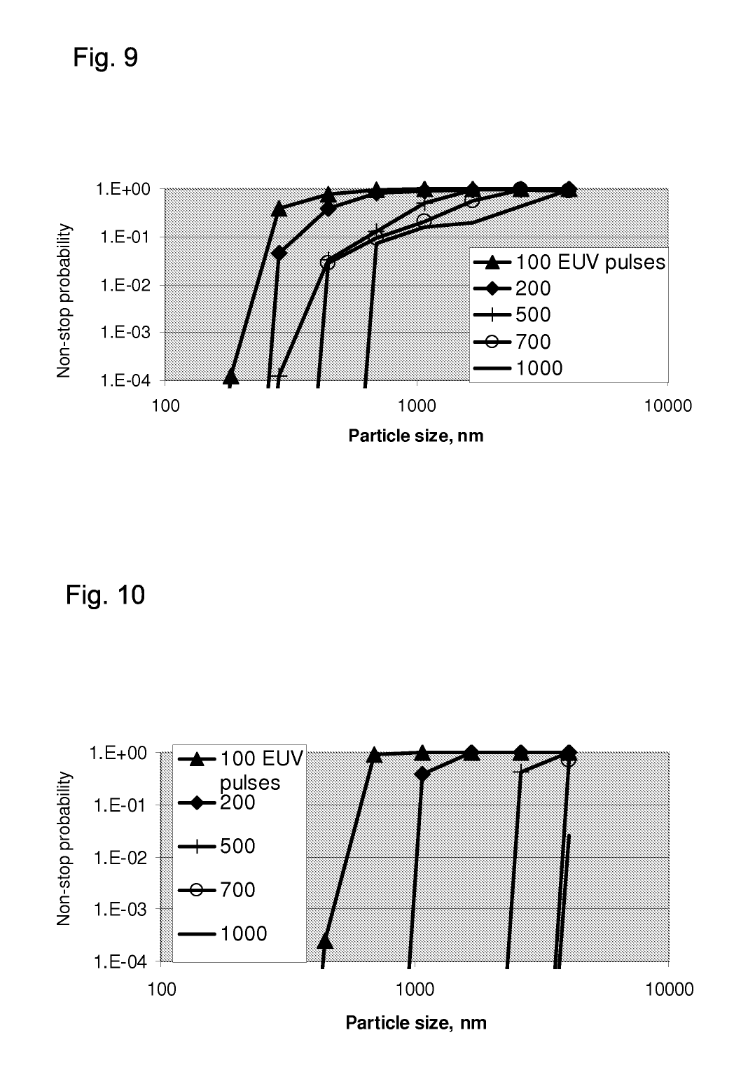

FIGS. 9 and 10 depict the results of simulations of using a system such as that depicted in FIG. 8 for different contaminant particles. Specifically, FIG. 9, according to an embodiment of the present invention, depicts the results for contaminant particles of a material with a relatively high secondary electron emission coefficient, such as a metal. In particular, the secondary electron emission coefficient k is 0.02. FIG. 10 depicts the results for a relatively low secondary electron emission coefficient material, such as an insulator, specifically one in which k is 0.002. In both FIGS. 9 and 10, the first stage of the voltage regime is provided by the first pair of electrodes 61, using an AC voltage of 40V, 100 MHz, providing 0.03 W/cm². The intermediate stage is provided by a voltage of 200V, 10 MHz from the start of each pulse of the beam of EUV radiation for 6.5 μs, applied to the second pair of electrodes 62. The second stage is 200V DC, also applied to the second pair of electrodes 62 from the end of the intermediate stage to the start of the next pulse of the beam of EUV radiation.

As shown in FIGS. 9 and 10, according to embodiments of the present invention, the non-stop probability is a significant improvement over a previously known system using a constant DC voltage, namely as shown in FIG. 6. However, with an embodiment such as that depicted in FIG. 8, particles of different materials have a different stopping efficiency.

It should be specifically appreciated that an embodiment such as that depicted in FIG. 8, namely in which the first and second stages of the voltage regime are spatially separated could be used for a system in which a non-pulsed beam of radiation is used. In such an arrangement, the first stage can be an AC voltage configured to increase the plasma density in order to promote the charging of the contaminant particles by the plasma. The second stage of the regime of voltages can be a DC voltage used to remove the charged contaminant particles.

Although specific reference may have been made above to the use of embodiments of the invention involving lithographic apparatus in the manufacture of ICs, it should be understood that the invention described herein may have other applications, such as the manufacture of integrated optical systems, guidance and detection patterns for magnetic domain memories, flat-panel displays, liquid-crystal displays (LCDs), thin-film magnetic heads, etc. The skilled artisan will appreciate that, in the context of such alternative applications, any use of the terms “wafer” or “die” herein can be considered as synonymous with the more general terms “substrate” or “target portion”, respectively. The substrate referred to herein can be processed, before or after exposure, in for example a track (a tool that typically applies a layer of resist to a substrate and develops the exposed resist), a metrology tool, and/or an inspection tool. Where applicable, the disclosure herein can be applied to such and other substrate processing tools. Further, the substrate can be processed more than once, for example in order to create a multi-layer IC, so that the term substrate used herein may also refer to a substrate that already contains multiple processed layers.

Although specific reference may have been made above to the use of embodiments of the invention in the context of optical lithography, it will be appreciated that the invention can be used in other applications, for example imprint lithography, and where the context allows, is not limited to optical lithography. In imprint lithography a topography in a patterning device defines the pattern created on a substrate. The topography of the patterning device can be pressed into a layer of resist supplied to the substrate whereupon the resist is cured by applying electromagnetic radiation, heat, pressure or a combination thereof. The patterning device is moved out of the resist leaving a pattern in it after the resist is cured.

The term “lens,” where the context allows, may refer to any one or combination of various types of optical components, including refractive, reflective, magnetic, electromagnetic, and electrostatic optical components.

While specific embodiments of the invention have been described above, it will be appreciated that the invention can be practiced otherwise than as described. For example, the invention may take the form of a computer program containing one or more sequences of machine-readable instructions describing a method as disclosed above, or a data storage medium (e.g., semiconductor memory, magnetic or optical disk) having such a computer program stored therein.

For example, software functionalities of a computer system involve programming, including executable codes, may can be used to implement the above described inspection methods. The software code can be executable by a general-purpose computer. In operation, the code and possibly the associated data records can be stored within a general-purpose computer platform. At other times, however, the software may can be stored at other locations and/or transported for loading into an appropriate general-purpose computer system. Hence, the embodiments discussed above involve one or more software products in the form of one or more modules of code carried by at least one machine-readable medium. Execution of such codes by a processor of the computer system enables the platform to implement the functions in essentially the manner performed in the embodiments discussed and illustrated herein.

As used herein, terms such as computer or machine “readable medium” refer to any medium that participates in providing instructions to a processor for execution. Such a medium can take many forms, including but not limited to, non-volatile media, volatile media, and transmission media. Non-volatile media include, for example, optical or magnetic disks, such as any of the storage devices in any computer(s) operating as discussed above. Volatile media include dynamic memory, such as main memory of a computer system. Physical transmission media include coaxial cables, copper wire, and fiber optics, including the wires that comprise a bus within a computer system. Carrier-wave transmission media can take the form of electric or electromagnetic signals, or acoustic or light waves such as those generated during radio frequency (RF) and infrared (IR) data communications. Common forms of computer-readable media therefore include, for example: a floppy disk, a flexible disk, hard disk, magnetic tape, any other magnetic medium, a CD-ROM, DVD, any other optical medium, less commonly used media such as punch cards, paper tape, any other physical medium with patterns of holes, a RAM, a PROM, and EPROM, a FLASH-EPROM, any other memory chip or cartridge, a carrier wave transporting data or instructions, cables or links transporting such a carrier wave, or any other medium from which a computer can read or send programming codes and/or data. Many of these forms of computer readable media may be involved in carrying one or more sequences of one or more instructions to a processor for execution.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The present invention has been described above with the aid of functional building storing blocks illustrating the implementation of specified functions and relationships thereof. The boundaries of these functional building storing blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. A system for removing contaminant particles from the path of a beam of EUV radiation in a lithographic apparatus, comprising:
(a) at least one pair of electrodes provided on opposite sides of the path of the beam of EUV radiation;
(b) a voltage source, configured to provide a controlled voltage between the at least one pair of electrodes; and
(c) a controller, configured to control the voltage provided between the at least one pair of electrodes;
wherein the controller is configured to provide a regime of voltages between the at least one pair of electrodes, the regime including a first stage in which an AC voltage is provided to a pair of the electrodes, and a second stage in which a DC voltage is provided to a pair of the electrodes.

2. A system for removing contaminant particles according to claim 1, wherein the required voltages of each of the stages of the regime are provided between the same pair of electrodes in successive respective periods of time.

3. A system for removing contaminant particles according to claim 2, wherein the beam of EUV radiation is provided by a pulsed source; and the controller is configured such that the sum of the time periods of the stages of the regime of voltages corresponds to the time between the start of successive pulses of the beam of EUV radiation.

4. A system for removing contaminant particles according to claim 2 or 3, wherein the frequency and potential of the AC voltage of the first stage is selected such that, for the configuration of the system, the AC voltage provided between the pair of electrodes increases the density of a plasma generated by the beam of EUV radiation.

5. A system for removing contaminant particles according to claim 4, wherein the frequency of the AC voltage of the first stage is between 20 and 100 MHz.

6. A system for removing contaminant particles according to claim 4 or 5, wherein the magnitude of the AC voltage of the first stage is between 40 and 200V.

7. A system for removing contaminant particles according to any one of claims 4 to 6, wherein the power supplied to the pair of electrodes by the AC voltage is between 0.005 and 0.04 W/cm².

8. A system for removing contaminant particles according to claim 2 or 3, wherein the frequency and magnitude of the AC voltage of the first stage is selected such that, for the configuration of the system, the AC voltage provided between the pair of electrodes dissipates a plasma generated by the beam of EUV radiation.

9. A system for removing contaminant particles according to claim 8, wherein the frequency of the AC voltage of the first stage is between 0.1 and 20 MHz, desirably 10 MHz.

10. A system for removing contaminant particles according to claim 8 or 9, wherein the magnitude of the AC voltage of the first stage is between 10 and 400V, desirably 200V.

11. A system for removing contaminant particles according to claim 3, wherein the regime of voltages includes an intermediate stage, provided between the first and second stages, in which an AC voltage is provided to a pair of the electrodes;
wherein the frequency of the AC voltage of the first stage is higher than the frequency of the AC voltage of the intermediate stage.

12. A system for removing contaminant particles according to claim 11, wherein the frequency and magnitude of the AC voltage of the first stage and the intermediate stage are selected such that, for the configuration of the system, the AC voltage provided between the pair of electrodes in the first stage increases the density of a plasma generated by the beam of EUV radiation and the AC voltage provided between the pair of electrodes in the second stage dissipates the plasma.

13. A system for removing contaminant particles according to claim 12, wherein the frequency of the AC voltage of the first stage is between 20 and 100 MHz.

14. A system for removing contaminant particles according to claim 12 or 13, wherein the magnitude of the AC voltage of the first stage is between 40 and 200V.

15. A system for removing contaminant particles according to any one of claims 12 to 14, wherein the power supplied to the pair of electrodes by the AC voltage of the first stage is between 0.005 and 0.04 W/cm².

16. A system for removing contaminant particles according to any one of claims 12 to 15, wherein the frequency of the AC voltage of the intermediate stage is between 0.1 and 20 MHz, desirably 10 MHz.

17. A system for removing contaminant particles according to any one of claims 12 to 16, wherein the magnitude of the AC voltage of the intermediate stage is between 10 and 400V, desirably 200V.

18. A system for removing contaminant particles according to any one of claims 11 to 17, wherein the period of time of the first stage of the regime corresponds to between 5 and 15%, desirably less than 10%, of the time between the start of successive pulses of the beam of EUV radiation.

19. A system for removing contaminant particles according to any one of claims 11 to 18, wherein the period of time of the intermediate stage of the regime corresponds to less than 30%, desirably less than 20% of the time between the start of successive pulses of the beam of EUV radiation.

20. A system for removing contaminant particles according to any one of claims 3 to 19, wherein the period of time of the second stage of the regime corresponds to at least 40%, at least 50% or at least 60% of the time between the start of successive pulses of the beam of EUV radiation.

21. A system for removing contaminant particles according to claim 1, wherein the at least one pair of electrodes comprises first and second pairs of electrodes provided at respective positions along an axis of the beam of EUV radiation such that the first pair of electrodes is closer to a source of contaminant particles than the second pair of electrodes;
wherein the voltage of the first stage of the regime of voltages is applied to the first pair of electrodes and the voltage of the second stage of the regime of voltages is applied to the second pair of electrodes.

22. A system for removing contaminant particles according to claim 21, wherein the regime of voltages includes an intermediate stage, provided between the first and second stages, in which an AC voltage is provided to a pair of the electrodes;
wherein the frequency of the AC voltage in the first stage is higher than the frequency of the AC voltage of the intermediate stage.

23. A system for removing contaminant particles according to claim 22, wherein the required voltages of the intermediate and second stages of the regime are provided between the second pair of electrodes in successive respective periods of time.

24. A system for removing contaminant particles according to any one of the preceding claims, wherein the DC voltage of the second stage is selected from the range of 100 to 400V, desirably 200V.

25. A lithographic apparatus including a system for removing contaminant particles according to any one of the preceding claims.

26. A lithographic apparatus including a system for removing contaminant particles according to claim 25, wherein the system for removing contaminant particles is configured to remove contaminant particles from the EUV beam path between an illumination system and a patterning device configured to impart a pattern to the beam of radiation.

27. A method for removing contaminant particles from the path of a beam of EUV radiation in a lithographic apparatus, comprising:
providing at least one pair of electrodes provided on opposite sides of the path of the beam of EUV radiation; and
providing a regime of voltages between the at least one pair of electrodes, the regime including a first stage, in which an AC voltage is provided to a pair of the electrodes, and a second stage, in which a DC voltage is provided to the electrodes.

28. A device manufacturing method comprising projecting a patterned beam of EUV radiation onto a substrate, comprising using the method of claim 27 to remove contaminant particles from at least a part of the path of the beam of EUV radiation.
